(19) United States
(12) Patent Application Publication
(10) Pub. No.: US 2025/0335960 A1
(43) Pub. Date: Oct. 30, 2025

(54) User Interface Including an Item Inventory with Freshness Indicators Predicted by a Machine Learning Model

(71) Applicant: Maplebear Inc., San Francisco, CA (US)

(72) Inventors: Kenneth Jason Sanchez, Orange, CA (US); Samuel Sherman, Seattle, WA (US); Daniely Zoller Cruz, Mt. Juliet, TN (US); Christopher Billman, Chicago, IL (US); Benjamin Knight, Oakland, CA (US); Rebecca Younis, Rochester, NY (US)

(21) Appl. No.: 18/651,544

(22) Filed: Apr. 30, 2024

(51) Int. Cl. G06Q 30/0601; G06Q 10/087

(52) U.S. Cl. CPC G06Q 30/0627; G06Q 10/087; G06Q 30/0631; G06Q 30/0635

(57) ABSTRACT

An online concierge system receives, from a user client device associated with a user of the online concierge system, a request to access a user interface including information describing one or more items included among an inventory at a retailer location. The system then retrieves a set of item data for an item included among the inventory at the retailer location. The system accesses and applies a machine-learning model to predict a freshness satisfaction score for the item based at least in part on the set of item data for the item. The system then generates the user interface including the information describing the item(s) based at least in part on the freshness satisfaction score for the item and sends the user interface to the user client device, causing the user client device to display the user interface.

### BACKGROUND

Online concierge systems provide their users with the convenience of placing orders that are matched with pickers who service the orders on behalf of the users (e.g., by driving to retailer locations, collecting items included in the orders, and delivering the orders to the users). Items ordered by users may include perishable items. For example, the freshness of items included in an order, such as fruits, vegetables, or baked goods, may diminish over time, making them less appealing. In this example, once they reach the end of their shelf lives, the items may become spoiled.

Due to the perishability of items that may be ordered by users of online concierge systems, when placing orders, the users may be presented with descriptions of items that appear fresher than the items available at retailer locations from which the items are subsequently collected. For example, suppose that an ordering interface for an online concierge system includes descriptions of fruits included among an inventory at a retailer location. In this example, if the descriptions include default images depicting the fruits, in which the fruits appear to be fresh even though some of the fruits available at the retailer location are overripe or moldy, users who order the fruits via the ordering interface may be disappointed with the items they receive. Therefore, the inability of online concierge systems to provide descriptions of items that reflect the freshness of the items available at retailer locations may negatively affect the ordering experiences of their users.

### SUMMARY

In accordance with one or more aspects of the disclosure, an online concierge system predicts a measure of satisfaction of a user with the freshness of an item included among an inventory at a retailer location. More specifically, an online concierge system receives, from a user client device associated with a user of the online concierge system, a request to access a user interface including information describing one or more items included among an inventory at a retailer location. The online concierge system then retrieves a set of item data for an item included among the inventory at the retailer location. The online concierge system accesses and applies a machine-learning model to predict a freshness satisfaction score for the item based at least in part on the set of item data for the item. The online concierge system then generates the user interface including the information describing the item(s) based at least in part on the freshness satisfaction score for the item. The online concierge system sends the user interface to the user client device, causing the user client device to display the user interface.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for predicting a measure of satisfaction of a user of an online concierge system with the freshness of an item included among an inventory at a retailer location, in accordance with one or more embodiments.

FIG. 4A illustrates an example of a user interface including information describing items included among an inventory at a retailer location, in accordance with one or more embodiments.

FIG. 4B illustrates examples of freshness satisfaction scores for items included among an inventory at a retailer location, in accordance with one or more embodiments.

FIG. 4C illustrates an example of a user interface including information describing items associated with at least a threshold freshness satisfaction score that are included among an inventory at a retailer location, in accordance with one or more embodiments.

### DETAILED DESCRIPTION

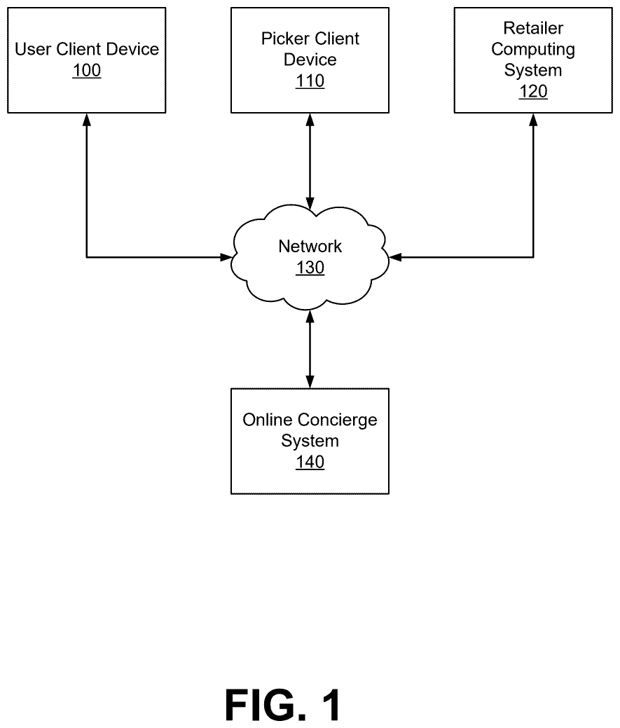

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, refers to a good or product that may be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user may use to place an order with the online concierge system 140. The ordering interface may be part of a client application operating on the user client device 100. The ordering interface allows the user to search for items that are available through the online concierge system 140 and the user may select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the items should be collected. The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the user's order to the picker in a collection interface. The collection interface is a user interface that provides information to the picker identifying items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer location, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker may use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. In some embodiments, the retailer computing system 120 is a client device (e.g., a personal or mobile computing device) operated by a retailer. As used herein, a “retailer” is an entity that operates a “retailer location,” which is a store, a warehouse, a building, a stand, a truck, or other location from which a picker can collect items. For example, a retailer may be a farmer or a farm employee that operates a stand at a farmer's market. As an additional example, a retailer may be an individual that operates a food stand or a food truck. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Furthermore, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

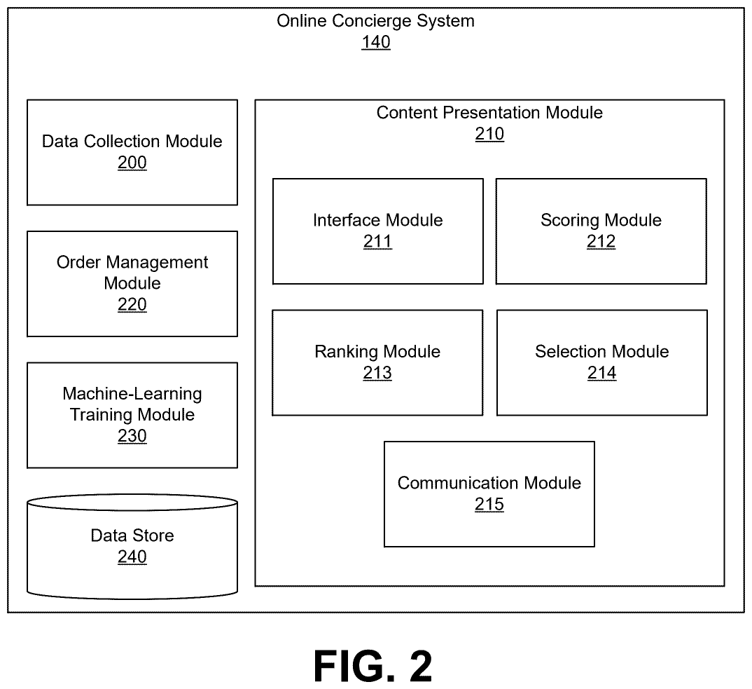

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provide portions of the payment from the user to the picker and the retailer. As an example, the online concierge system 140 may allow a user to order groceries from a grocery store retailer. The user's order may specify which groceries they want delivered from the grocery store and the quantities of each of the groceries. The user's client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

The data collection module 200 collects user data, which is information or data describing characteristics of a user. User data may include a user's name, address, shopping preferences, favorite items, dietary restrictions/preferences, or stored payment instruments. User data also may include demographic information associated with a user (e.g., age, gender, geographical region, etc.) or household information associated with the user (e.g., a number of people in the user's household, whether the user's household includes children or pets, etc.). The user data also may include default settings established by the user, such as a default retailer/retailer location, payment instrument, delivery location, or delivery timeframe.

User data further may include historical information associated with a user. For example, user data may include historical conversion information associated with a user, such as historical order or purchase information associated with the user. In this example, the historical order information may describe previous orders placed by the user with the online concierge system 140, such as one or more items included in each order (e.g., an item category, a size, a brand, a quantity, a price, etc. associated with each item), a time each order was placed, a retailer location from which the item(s) included in each order was/were collected, etc. Continuing with this example, the historical order information also may include a review, a rating, or instructions associated with each order provided by the user, as well as information indicating whether one or more items were removed from or replaced in each order, whether each order was associated with an issue, a complaint, a refund, a cancellation, etc. In the above example, the historical purchase information similarly may describe previous purchases made by the user and may include information describing one or more items included in each purchase, a time each purchase was made, information describing a retailer location from which each purchase was made, etc. As yet another example, user data may include historical interaction information describing previous interactions by a user with items or other types of content (e.g., coupons, advertisements, recipes, etc.) presented by the online concierge system 140. In this example, the historical interaction information may describe the items or other types of content, a time of each interaction, a type of each interaction, etc.

User data also may include information describing a measure of satisfaction of a user with the freshness of an item included among an inventory at a retailer location. A measure of satisfaction of a user with the freshness of an item may be described by a freshness satisfaction score that indicates the measure of satisfaction. For example, a freshness satisfaction score for an item may correspond to a value that is proportional to a measure of satisfaction of a user with the freshness of the item, in which a high score indicates the user is highly satisfied with the freshness of the item and a low score indicates the user is highly dissatisfied with the freshness of the item. A measure of satisfaction of a user with the freshness of an item may be received from the user (e.g., via a survey, a questionnaire, etc. sent to a user client device 100 associated with the user), derived (e.g., from a review for an order that includes the item, as described below), or predicted (e.g., using the scoring module 212 of the content presentation module 210, as also described below). Furthermore, information describing a measure of satisfaction of a user with the freshness of an item may be stored in the data store 240 in association with various types of information. For example, a freshness satisfaction score for an item included among an inventory at a retailer location may be stored in association with information describing the item and the retailer location, a time at which it was predicted, a user associated with the score, etc. The data collection module 200 may collect the user data from sensors on the user client device 100 or based on the user's interactions with the online concierge system 140. The data collection module 200 also may collect the user data from the scoring module 212 of the content presentation module 210, as further described below.

The data collection module 200 also collects item data, which is information or data identifying and describing items that are available at a retailer location. The item data may include item identifiers for items that are available and may include quantities of items associated with each item identifier. Additionally, item data may also include attributes of items such as the sizes, colors, weights, stock keeping units (SKUs), serial numbers, prices, item categories, brands, qualities (e.g., freshness, ripeness, etc.), ingredients, materials, manufacturing locations, versions/varieties (e.g., flavors, low fat, gluten-free, organic, etc.), availabilities/seasonalities, or any other suitable attributes of the items. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination (a particular item at a particular retailer location), the item data may include a time that the item was last found, a time that the item was last not found (a picker looked for the item but could not find it), the rate at which the item is found, or the popularity of the item.

Item data may include additional types of information or data identifying and describing items that are available at a retailer location. In some embodiments, the item data also includes information describing the retailer location. For example, the item data for an item included among an inventory at a retailer location may describe a geographical location of the retailer location (e.g., an address and a time zone associated with the retailer location), operating hours for the retailer location, etc., as well as a retailer that operates the retailer location, such as a name of the retailer, a type of the retailer (e.g., a grocery retailer or a retailer of prepared foods), etc. The item data also may include a freshness satisfaction score for an item included among an inventory at a retailer location. As described above, a freshness satisfaction score for an item indicates a measure of satisfaction of a user with the freshness of the item. The item data also may include information describing a life cycle of an item. For example, the item data for an item corresponding to a fruit or a vegetable may include a harvest date associated with the item, a shipping and handling time associated with the item, an amount of time elapsed since the item became available for order or purchase from a retailer location, or a shelf life associated with the item (e.g., as a best by or a use by date, a number of days after the harvest date, etc.). In the above example, if the item is a different type of item, the item data also may include other types of information that may describe its life cycle (e.g., a date or a time it was made, packaged, etc.). Additionally, the item data may include information describing an environment in which an item should be stored (e.g., to prolong its shelf life). For example, the item data for an item may describe a temperature range of a location in which the item should be stored, an optimal humidity or light exposure associated with the location, etc.

Item data also may include information describing an inventory of an item at a retailer location. Information describing an inventory of an item at a retailer location may describe an amount or a quantity of the item that is available or expected to be available at the retailer location. For example, information describing an inventory of white peaches at a retailer location may describe a quantity of white peaches currently available at the retailer location, as well as information describing future shipments of white peaches to the retailer location (e.g., quantities of the white peaches included in each shipment, a shipment schedule for the white peaches, etc.). Information describing an inventory of an item at a retailer location also may include a set of images of the item captured at the retailer location. For example, information describing an inventory of strawberries at a farmer's market stand may include a set of images depicting the strawberries captured by a farmer or a farm employee that operates the stand (e.g., using a retailer computing system 120). In the above example, the set of images also or alternatively may be captured by one or more picker client devices 110 associated with one or more pickers while each picker was servicing an order at the farmer's market. Information describing an inventory of an item at a retailer location may also include environmental information associated with the item at the retailer location. For example, environmental information associated with an item corresponding to bananas may describe a location within a retailer location in which the bananas may be found, such as a temperature, a humidity, or a light exposure of the location or fluctuations in temperature, humidity, or light exposure of the location (if any). In this example, the environmental information associated with the item also may include a department associated with the location (e.g., a produce department), a visibility of the location (e.g., whether it is at the eye level of users), etc.

Item data also may include historical conversion information associated with an item included among an inventory at a retailer location. Historical conversion information associated with an item may include times, prices, user data, quantities of the item, etc. associated with previous conversions associated with the item, a frequency with which the item was previously acquired, etc. For example, historical conversion information associated with an item corresponding to watermelon may describe a time of the day or a day of the week when watermelon was ordered or purchased most frequently from a retailer location. In this example, the historical conversion information also may describe attributes of users who ordered watermelon collected from the retailer location most frequently, who purchased watermelon most frequently from the retailer location, or who ordered/purchased the greatest quantities of watermelon from the retailer location. In the above example, the historical conversion information also may include a price of the watermelon included in each order or purchase and a quantity of the watermelon ordered/purchased.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as apples, oranges, lettuce, and cucumbers may be included in a “produce” item category. As an additional example, items such as bread, pasta, and cookies that are gluten-free may be included in a “gluten-free” item category, while items such as tortilla chips and tofu that are non-GMO may be included in a “non-GMO” item category. Furthermore, in various embodiments, an item may be included in multiple categories. For example, croissants may be included in a “croissant” item category, a “pastry” item category, and a “bakery” item category. The item categories may be human-generated and human-populated with items. The item categories also may be generated automatically by the online concierge system 140 (e.g., using a clustering algorithm). The data collection module 200 may collect item data from a retailer computing system 120, a picker client device 110, or a user client device 100. The data collection module 200 also may collect the item data from the scoring module 212 of the content presentation module 210, as further described below.

The data collection module 200 also collects picker data, which is information or data describing characteristics of pickers. For example, the picker data for a picker may include the picker's name, the picker's location, how often the picker has serviced orders for the online concierge system 140, a user rating for the picker, the retailers from which the picker has collected items, or the picker's previous shopping history. Additionally, the picker data may include preferences expressed by the picker, such as their preferred retailers for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects conversion data, such as order data or purchase data. Order data is information or data describing characteristics of an order. For example, order data may include item data for items that are included in an order, a delivery location for the order, a user associated with the order, a retailer location from which the user wants the ordered items collected, or a timeframe within which the user wants the order delivered. Order data may further include information describing how an order was serviced, such as which picker serviced the order, when the order was delivered, a rating that the user gave the order (e.g., for the collection of items included in the order or for the delivery of the order), or a review, a complaint, a refund, an issue, or a cancellation associated with the order. Order data also may include information describing a replacement or a removal of an item included in an order. In some embodiments, the order data includes user data for users associated with orders, such as user data for a user who placed an order or picker data for a picker who serviced the order. The order data also may include images or videos associated with an order (e.g., depicting one or more items included in the order), messages sent between a user client device 100 associated with a user who placed the order and a picker client device 110 associated with a picker who serviced the order, or any other suitable types of information. Purchase data is information or data describing characteristics of a purchase. Similar to the order data, the purchase data may include item data for items included in purchases or user data for users associated with purchases. For example, purchase data for a purchase may include item data for items that are included in the purchase, user data for a user who made the purchase, and information describing the purchase (e.g., a retailer location from which the user purchased the items and a date and time of the purchase). In some embodiments, the conversion data includes information or data describing characteristics of one or more additional types of conversions (e.g., adding an item to a shopping list, clicking on an item, etc.).

In some embodiments, the data collection module 200 also derives information from other data stored in the data store 240 and stores this derived information in the data store 240 (e.g., in association with the data from which it was derived). For example, suppose that a set of user data for a user describes previous orders placed by the user with the online concierge system 140 or previous purchases made by the user at retailer locations. In the above example, based on the previous orders/purchases, the data collection module 200 may derive a frequency with which the user orders/purchases items associated with various attributes (e.g., an item category, a ripeness, a color, a brand, a weight, etc. associated with each item), a percentage of items the user orders/purchases that are on sale, and types of items that the user orders/purchases from a particular retailer location.

Information derived by the data collection module 200 also may indicate whether a review for an order is positive or negative or whether it indicates a measure of satisfaction of a user with the freshness of an item. For example, the data collection module 200 may derive information indicating that a review is positive and indicates a measure of satisfaction of a user with the freshness of an item corresponding to fresh salmon if a review for an order including the salmon states: “Great job selecting the salmon!” In the above example, the data collection module 200 also may derive information indicating that the review is associated with a video depicting fresh salmon provided by the user in association with the review. Additionally, in the above example, suppose that an image depicting fresh salmon was communicated from a picker client device 110 associated with a picker servicing the order to a user client device 100 associated with the user. In this example, if a message subsequently communicated from the user client device 100 to the picker client device 110 indicated that the user was satisfied with the freshness of the salmon depicted in the image, the data collection module 200 also may derive information indicating that the review is associated with the image. The data collection module 200 may derive information using various techniques, such as natural language processing (NLP), computer-vision, speech recognition, or any other suitable technique or combination of techniques.

The content presentation module 210 selects content for presentation to a user. For example, the content presentation module 210 selects which items to present to a user while the user is placing an order. Components of the content presentation module 210 include: an interface module 211, a scoring module 212, a ranking module 213, a selection module 214, and a communication module 215, which are further described below.

The interface module 211 generates a user interface with which a user of the online concierge system 140 may interact and sends the user interface to a user client device 100 associated with the user, causing the user client device 100 to display the user interface. In some embodiments, the user interface is an ordering interface for the user to order items. In such embodiments, the interface module 211 populates the ordering interface with items that the user may select for adding to their order. In some embodiments, the interface module 211 presents a catalog of all items that are available to the user, which the user can browse to select items to order. Other components of the content presentation module 210 may identify items that the user is most likely to order and the interface module 211 may then present those items to the user. For example, the scoring module 212 may score items and the ranking module 213 may rank the items based on their scores. In this example, the selection module 214 may select items with scores that exceed some threshold (e.g., the top n items or the p percentile of items) and the interface module 211 then displays the selected items.

The interface module 211 may receive a request from a user client device 100 associated with a user of the online concierge system 140 to access the user interface, in which the user interface includes information describing one or more items included among an inventory at a retailer location. For example, the interface module 211 may receive a request from a user client device 100 associated with a user for information describing items included among an inventory at a retailer location that match a search query received from the user client device 100. In this example, the interface module 211 may then generate the user interface including a set of information associated with each of one or more items identified by other components of the content presentation module 210 (e.g., the scoring module 212, the ranking module 213, and the selection module 214) based on the request. Continuing with this example, the interface module 211 may send the user interface to the user client device 100, causing the user client device 100 to display the user interface. Alternatively, in the above example, if the request is for an ordering interface for the user to order items included among the inventory at the retailer location, the other components of the content presentation module 210 may identify items that the user is most likely to order and the interface module 211 may then generate the ordering interface that includes those items and send the ordering interface to the user client device 100.

The interface module 211 may generate the user interface based on a freshness satisfaction score for an item predicted by the scoring module 212 (described below). In various embodiments, the interface module 211 generates an indicator based on the freshness satisfaction score for the item and generates the user interface including information describing the item, in which the information describing the item includes the indicator. The indicator may correspond to a value or a visual element (e.g., an image of a gauge, a meter, etc.) indicating a measure of satisfaction of a user with the freshness of an item. For example, the interface module 211 may generate a freshness indicator for each of multiple items included in the user interface based on a freshness satisfaction score for each item, in which the freshness indicator indicates where a user's measure of satisfaction with the freshness of a corresponding item falls along a range. In this example, if the range is from 0 to 100, with 0 being the lowest and 100 being the highest, items with freshness satisfaction scores of 0, 50, and 100 may have freshness indicators indicating that they are “not so fresh,” “fairly fresh,” and “very fresh,” respectively. Continuing with this example, the interface module 211 may generate the user interface including the freshness indicator and other information (e.g., a name, an image, a price, etc.) describing each item.

In some embodiments, the selection module 214 determines whether a freshness satisfaction score for an item is at least a threshold score and the interface module 211 generates the user interface including information describing the item if the freshness satisfaction score for the item is at least the threshold score. In such embodiments, the user interface also includes information indicating the freshness of the item. For example, the selection module 214 may compare a freshness satisfaction score for an item included among an inventory at a retailer location to a threshold score and determine whether the freshness satisfaction score is at least the threshold score and repeat this process for additional items included among the inventory at the retailer location. In this example, if the selection module 214 determines the freshness satisfaction score for an item is at least the threshold score, the interface module 211 may include information (e.g., a name, an image, a price, etc.) describing the item in the user interface, in which the user interface indicates the items included in the user interface are fresh (e.g., by labeling them as “Fresh In Stock”). In one or more embodiments, the threshold score is determined for a user based on the user's preferences for freshness, which may be explicitly provided or inferred based on historical behavior. Furthermore, in the above example, if the selection module 214 determines the freshness satisfaction score for an item is not at least the threshold score, the interface module 211 may not include information describing the item in the user interface.

The scoring module 212 may use an item selection model to score items for presentation to a user. An item selection model is a machine-learning model that is trained to score items for a user based on item data for the items and user data for the user. For example, the item selection model may be trained to determine a likelihood that the user will order an item. In some embodiments, the item selection model uses item embeddings describing items and user embeddings describing users to score items. These item embeddings and user embeddings may be generated by separate machine-learning models and may be stored in the data store 240.

In some embodiments, the scoring module 212 scores items based on a search query received from the user client device 100. A search query is free text for a word or set of words that indicate items of interest to the user. The scoring module 212 scores items based on a relatedness of the items to the search query. For example, the scoring module 212 may apply natural language processing (NLP) techniques to the text in the search query to generate a search query representation (e.g., an embedding) that represents characteristics of the search query. The scoring module 212 may use the search query representation to score candidate items for presentation to a user (e.g., by comparing a search query embedding to an item embedding).

In some embodiments, the scoring module 212 scores items based on a predicted availability of an item. The scoring module 212 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The scoring module 212 may apply a weight to the score for an item based on the predicted availability of the item. Alternatively, an item may be filtered out from presentation to a user by the selection module 214 based on whether the predicted availability of the item exceeds a threshold.

The scoring module 212 also may retrieve data from the data store 240. As described above, data stored in the data store 240 includes various types of data, such as item data, user data, conversion data, etc. For example, the scoring module 212 may retrieve a set of item data for an item included among an inventory at a retailer location, such as information describing the retailer location, the inventory of the item at the retailer location (e.g., environmental information associated with the item at the retailer location or a set of images of the item captured at the retailer location), a life cycle of the item, or an environment in which the item should be stored. In this example, the set of item data also may include attributes (e.g., an availability/seasonality, one or more item categories, etc.) associated with the item, historical conversion information associated with the item, etc. In this example, the scoring module 212 also may retrieve a set of user data for each of one or more users, such as information describing each user's favorite items or dietary restrictions/preferences. In the above example, the set of user data also may include demographic or household information associated with each user, historical information (e.g., historical conversion or interaction information) associated with each user, or information describing a measure of satisfaction of each user with the freshness of an item. In the above example, the scoring module 212 also may retrieve a set of conversion data for each of one or more conversions (e.g., one or more orders or purchases), such as a time associated with each conversion, information describing a retailer or a retailer location associated with each conversion, or a rating, review, complaint, refund, issue, cancellation, or replacement/removal (of an item) associated with each conversion (if any). In this example, the set of conversion data also may include item data for each item associated with each conversion, user data for a user associated with each conversion, etc.

The scoring module 212 also may predict freshness satisfaction scores for items. As described above, a freshness satisfaction score for an item included among an inventory at a retailer location indicates a measure of satisfaction of a user with the freshness of the item. The scoring module 212 may predict a freshness satisfaction score for an item based on data it retrieves from the data store 240 (e.g., item data or conversion data for one or more items, user data for one or more users, etc.). The scoring module 212 may do so using various techniques applied to the retrieved data, such as natural language processing (NLP), computer-vision, speech recognition, or any other suitable technique or combination of techniques. The scoring module 212 may associate different weights with different types of information used to make the prediction (e.g., by weighting newer data more heavily than older data). For example, when predicting a freshness satisfaction score for an item, the scoring module 212 may weight images of the item captured at a retailer location earlier in the day more heavily than images of the item captured at the retailer location during the previous day. In some embodiments, a freshness satisfaction score is generalized for multiple users of the online concierge system 140, such that it indicates a measure of satisfaction of the users with the freshness of an item. In other embodiments, a freshness satisfaction score is specific to a particular user of the online concierge system 140, such that it indicates a measure of satisfaction of the user with the freshness of an item.

The following example illustrates how the scoring module 212 may predict a freshness satisfaction score for an item corresponding to fresh tuna included among an inventory at a retailer location, in which the score is generalized for multiple users of the online concierge system 140. Suppose that the scoring module 212 retrieves a set of item data for the fresh tuna, in which the set of item data includes information describing the retailer location or a life cycle of fresh tuna. In this example, the set of item data also may include one or more item categories associated with the fresh tuna, freshness satisfaction scores for the fresh tuna and other items associated with the item category/categories included among the inventory at the retailer location, and images depicting the fresh tuna captured at the retailer location. In the above example, suppose that the scoring module 212 also retrieves a set of conversion data associated with the fresh tuna including reviews indicating measures of satisfaction of users with the freshness of the fresh tuna.

Continuing with the above example, based on the retrieved information, the scoring module 212 may predict a freshness satisfaction score for the fresh tuna that is generalized for multiple users of the online concierge system 140. In this example, the freshness satisfaction score may be proportional to various retrieved values, such as an average freshness satisfaction score for the items associated with the item category/categories, the shelf life of fresh tuna, etc. In the above example, the freshness satisfaction score also may be inversely proportional to other retrieved values, such as an amount of time elapsed since the fresh tuna was caught, its shipping and handling time, the amount of time elapsed since it was delivered to the retailer location, etc. Continuing with this example, the freshness satisfaction score also may be proportional to a number of characteristics of the fresh tuna depicted in the images indicating its freshness (e.g., shiny and tight scales, clear eyes, etc.) and inversely proportional to a number of characteristics of the fresh tuna depicted in the images indicating its lack of freshness (e.g., dull and loose scales, cloudy eyes, etc.). In this example, the freshness satisfaction score also may be proportional to a number of the reviews that are positive and inversely proportional to a number of the reviews that are negative, in which newer reviews are weighted more heavily than older reviews.

The following example illustrates how the scoring module 212 may predict a freshness satisfaction score for an item corresponding to bananas included among an inventory at a retailer location, in which the score is specific to a particular user of the online concierge system 140. Suppose that the scoring module 212 retrieves a set of item data for the bananas, in which the set of item data includes information describing the retailer location or a life cycle of bananas. In this example, the set of item data also may include one or more item categories associated with the bananas, freshness satisfaction scores specific to the user for items associated with the item category/categories included among the inventory at the retailer location, and images depicting the bananas captured at the retailer location. Continuing with this example, the scoring module 212 also may retrieve a set of user data for the user including information indicating that green bananas are one of the user's favorite items and historical order information describing previous orders placed by the user that were associated with positive reviews indicating a measure of satisfaction of the user with the freshness of bananas included in the orders and videos depicting the bananas.

In the above example, based on the retrieved information, the scoring module 212 may predict a freshness satisfaction score for the bananas that is specific to the user. In this example, the freshness satisfaction score may be proportional to various retrieved values, such as an average freshness satisfaction score specific to the user for the items associated with the item category/categories, the shelf life of bananas, etc. In the above example, the freshness satisfaction score also may be inversely proportional to other retrieved values, such as an amount of time elapsed since the bananas were picked, their shipping and handling time, the amount of time elapsed since they were delivered to the retailer location, etc. Continuing with this example, the freshness satisfaction score also may be proportional to a measure of similarity between the colors of the bananas depicted in the images captured at the retailer location and the bananas depicted in the videos associated with the user's previous orders.

In some embodiments, the scoring module 212 predicts a freshness satisfaction score for an item using a freshness satisfaction prediction model. A freshness satisfaction prediction model is a machine-learning model trained to predict a freshness satisfaction score for an item included among an inventory at a retailer location. To use the freshness satisfaction prediction model, the scoring module 212 may access the model (e.g., from the data store 240) and apply the model to a set of inputs. The set of inputs may include various types of data retrieved by the scoring module 212 described above. For example, the scoring module 212 may access and apply the freshness satisfaction prediction model to a set of inputs including a set of item data for an item included among an inventory at a retailer location. In the above example, if the freshness satisfaction score being predicted is specific to a particular user of the online concierge system 140, the set of inputs also may include a set of user data for the user.

Once the scoring module 212 applies the freshness satisfaction prediction model to a set of inputs, the scoring module 212 may then receive an output from the model. The output may include a value corresponding to the freshness satisfaction score for the item. The scoring module 212 may then store the freshness satisfaction score in the data store 240 among a set of item data for the item or among a set of user data for a user associated with the score (if any). Additionally, the freshness satisfaction score may be stored in association with various types of information (e.g., information associated with the item, information associated with a user associated with the score, etc.). In the above example, the freshness satisfaction score may be stored among the set of item data for the item in association with information identifying the retailer location, a time at which it was predicted, information describing the user, etc. In some embodiments, the freshness satisfaction prediction model may be trained by the machine-learning training module 230, as described below.

As described above, the ranking module 213 may rank items included among an inventory at a retailer location based on a score for each item. In some embodiments, the ranking module 213 ranks the items based on a freshness satisfaction score predicted for each item. For example, the ranking module 213 may rank items from highest to lowest based on a freshness satisfaction score for each item, in which an item associated with a highest freshness satisfaction score is ranked the highest and an item associated with a lowest freshness satisfaction score is ranked the lowest. Alternatively, in the above example, if the scoring module 212 scores each item based on other types of information (e.g., a likelihood that a user will order the item, a relatedness of the item to a search query, or a predicted availability of the item), the ranking module 213 may rank the items based on the score for each item.

The selection module 214 may select items based on scores or rankings associated with the items and the interface module 211 may include information describing the selected items in a user interface (e.g., the ordering interface). In some embodiments, the selection module 214 selects one or more items with scores (e.g., freshness satisfaction scores) or rankings that exceed some threshold. The selection module 214 also may retrieve a set of information associated with each selected item that the interface module 211 includes in the user interface. For example, if a freshness satisfaction score for an item is at least a threshold score and the selection module 214 selects the item, the selection module 214 may retrieve a name of the item, an image of the item captured at a retailer location, a price of the item, and a description of the item.

The communication module 215 facilitates communication between the online concierge system 140 and a retailer computing system 120 operated by a retailer. The communication module 215 may do so by sending a message (e.g., a text message) to the retailer computing system 120 for presentation to the retailer. The retailer may use the retailer computing system 120 to send a message to the communication module 215 in a similar manner. The communication module 215 also may allow the online concierge system 140 and a retailer computing system 120 to communicate via audio or video communications (e.g., a phone call, a voice-over-IP call, or a video call), or via any other suitable method of communication.

The communication module 215 may send information to a retailer computing system 120 operated by a retailer that includes information describing a measure of satisfaction of a user with the freshness of an item included among an inventory at a retailer location operated by the retailer. For example, the communication module 215 may send a message to a retailer computing system 120 operated by a retailer, in which the message includes a freshness satisfaction score for an item included among an inventory at a retailer location operated by the retailer. The communication module 215 also may send additional types of information to a retailer computing system 120 operated by a retailer, such as information describing an environment in which an item should be stored (e.g., to prolong its shelf life). In the above example, if the freshness satisfaction score for the item is less than a threshold score, the message also may include a suggestion for the retailer to check that an environment in which the item is stored is optimal. In this example, the message also may include information describing an environment in which the item should be stored (e.g., an optimal temperature range of a location in which the item should be stored, an optimal humidity or light exposure associated with the location, etc.).

The order management module 220 manages orders for items from users. The order management module 220 receives orders from user client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to assign an order to a picker based on a delivery timeframe requested by the user who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer. The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or conversion data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

In embodiments in which the scoring module 212 accesses and applies the freshness satisfaction prediction model to predict a freshness satisfaction score for an item included among an inventory at a retailer location, the machine-learning training module 230 may train the freshness satisfaction prediction model. The machine-learning training module 230 may train the freshness satisfaction prediction model via supervised learning or using any other suitable technique or combination of techniques based on various types of data stored in the data store 240 or any other suitable types of data. For example, the machine-learning training module 230 may train the freshness satisfaction prediction model based on user data, item data, and conversion data stored in the data store 240.

To illustrate an example of how the machine-learning training module 230 may train the freshness satisfaction prediction model, suppose that the machine-learning training module 230 receives a set of training examples including various attributes of items included among an inventory at each of one or more retailer locations. In this example, the set of training examples may describe a life cycle of each item, an inventory of the item at a retailer location (e.g., a set of images of each item captured at the retailer location), historical conversion information associated with each item, etc. In the above example, the set of training examples also may include attributes of conversions by users of the online concierge system 140, such as information describing one or more items included in each order placed by a user or each purchase made by a user, a time associated with each order/purchase, information describing a retailer location associated with each order/purchase, etc. In this example, the set of training examples also may include attributes of the users associated with the conversions, such as each user's favorite items, demographic or household information associated with each user, historical information associated with each user, etc. In the above example, the machine-learning training module 230 also may receive labels which represent expected outputs of the freshness satisfaction prediction model, in which a label describes a measure of satisfaction of a user with the freshness of a set of items associated with a corresponding conversion. Continuing with this example, the machine-learning training module 230 may then train the freshness satisfaction prediction model based on the attributes, as well as the labels by comparing its output from input data of each training example to the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In situations in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, conversion data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

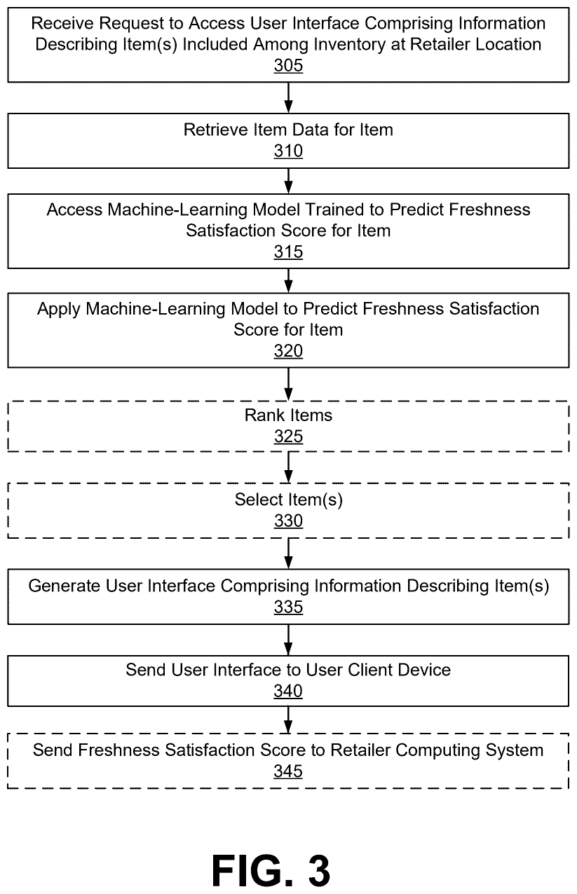

FIG. 3 is a flowchart of a method for predicting a measure of satisfaction of a user of an online concierge system with the freshness of an item included among an inventory at a retailer location, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

The online concierge system 140 receives 305 (e.g., via the interface module 211) a request from a user client device 100 associated with a user of the online concierge system 140 to access a user interface (e.g., an ordering interface), in which the user interface includes information describing one or more items included among an inventory at a retailer location. As described above, a retailer location is a store, a warehouse, a building, a stand (e.g., at a farmer's market), a truck (e.g., a food truck), or other location from which a picker can collect items. As also described above, a retailer location is operated by a retailer, which is an entity (e.g., a farmer, a farm employee, or other individual).

The online concierge system 140 then retrieves 310 (e.g., using the scoring module 212) a set of item data for an item included among the inventory at the retailer location (e.g., from the data store 240). In some embodiments, the online concierge system 140 also retrieves (step 310) additional types of data. Examples of such types of data include item data for other items, user data for one or more users, conversion data for one or more conversions, etc. (e.g., retrieved 310 from the data store 240).

The online concierge system 140 then predicts (e.g., using the scoring module 212) a freshness satisfaction score for the item. As described above, a freshness satisfaction score for an item included among an inventory at a retailer location indicates a measure of satisfaction of a user with the freshness of the item. The online concierge system 140 may predict the freshness satisfaction score for the item based on the data it retrieves 310. The online concierge system 140 may do so using various techniques applied to the retrieved data, such as natural language processing (NLP), computer-vision, speech recognition, or any other suitable technique or combination of techniques. The online concierge system 140 may associate (e.g., using the scoring module 212) different weights with different types of information used to make the prediction (e.g., by weighting newer data more heavily than older data). In some embodiments, the freshness satisfaction score is generalized for multiple users of the online concierge system 140, such that it indicates a measure of satisfaction of the users with the freshness of the item. In other embodiments, the freshness satisfaction score is specific to the user from which the request was received 305, such that it indicates a measure of satisfaction of the user with the freshness of the item.

In some embodiments, the online concierge system 140 predicts the freshness satisfaction score for the item using a freshness satisfaction prediction model. A freshness satisfaction prediction model is a machine-learning model trained to predict a freshness satisfaction score for an item included among an inventory at a retailer location. To use the freshness satisfaction prediction model, the online concierge system 140 may access 315 (e.g., using the scoring module 212) the model (e.g., from the data store 240) and apply 320 (e.g., using the scoring module 212) the model to a set of inputs. The set of inputs may include various types of data retrieved 310 by the online concierge system 140 described above. Once the online concierge system 140 applies 320 the freshness satisfaction prediction model to the set of inputs, the online concierge system 140 may then receive (e.g., via the scoring module 212) an output from the model. The output may include a value corresponding to the freshness satisfaction score for the item. The online concierge system 140 may then store (e.g., using the scoring module 212) the freshness satisfaction score (e.g., in the data store 240) among the set of item data for the item or among the set of user data for the user. Additionally, the freshness satisfaction score may be stored in association with various types of information (e.g., information associated with the item, the user, etc.). In some embodiments, the freshness satisfaction prediction model may be trained by the online concierge system 140 (e.g., using the machine-learning training module 230). The online concierge system 140 may train the freshness satisfaction prediction model via supervised learning or using any other suitable technique or combination of techniques based on various types of data (e.g., stored in the data store 240) or any other suitable types of data.

In various embodiments, the online concierge system 140 ranks (step 325, e.g., using the ranking module 213) items included among the inventory at the retailer location based on a score for each item. As described above, each item may be scored based on a likelihood that the user will order the item, a relatedness of the item to a search query received from the user client device 100, or a predicted availability of the item. In some embodiments, the online concierge system 140 ranks 325 the items based on a freshness satisfaction score predicted for each item.

The online concierge system 140 may then select 330 (e.g., using the selection module 214) one or more items based on scores or rankings associated with the item(s). In some embodiments, the online concierge system 140 selects 330 one or more items with scores (e.g., freshness satisfaction scores) or rankings that exceed some threshold. The online concierge system 140 also may retrieve (e.g., using the selection module 214) a set of information associated with each selected item.

The online concierge system 140 then generates 335 (e.g., using the interface module 211) the user interface (e.g., the ordering interface). The online concierge system 140 may do so based on the freshness satisfaction score for the item (e.g., by including information describing the item(s) selected 330 based on the freshness satisfaction score for the item in the user interface). In various embodiments, the online concierge system 140 generates (e.g., using the interface module 211) an indicator based on the freshness satisfaction score for the item and generates 335 the user interface including information describing the item, in which the information describing the item includes the indicator. The indicator may correspond to a value or a visual element (e.g., an image of a gauge, a meter, etc.) indicating the measure of satisfaction of the user with the freshness of the item.

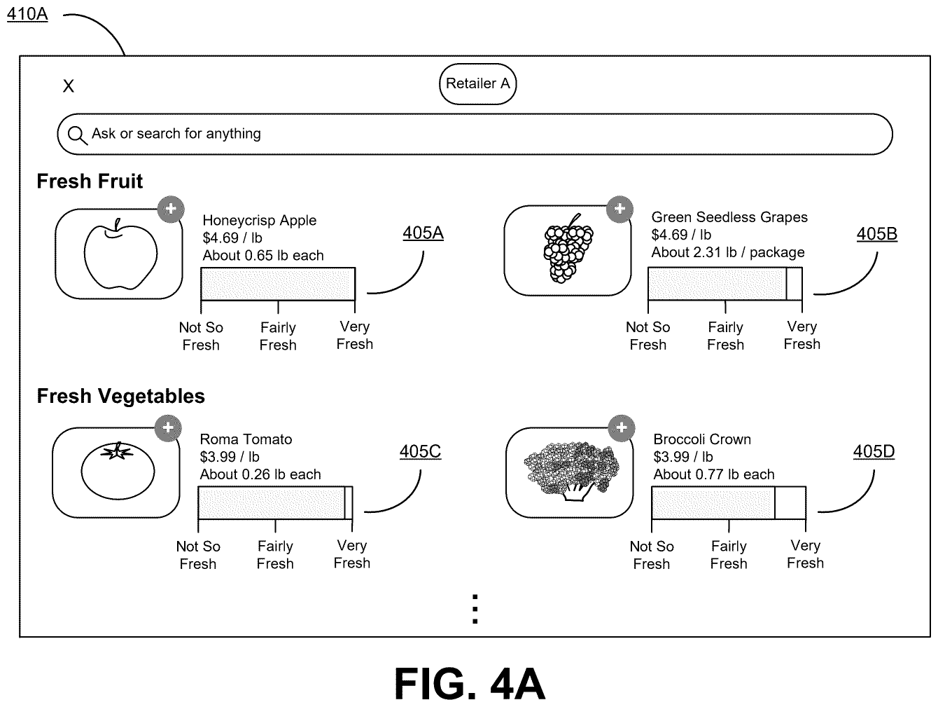

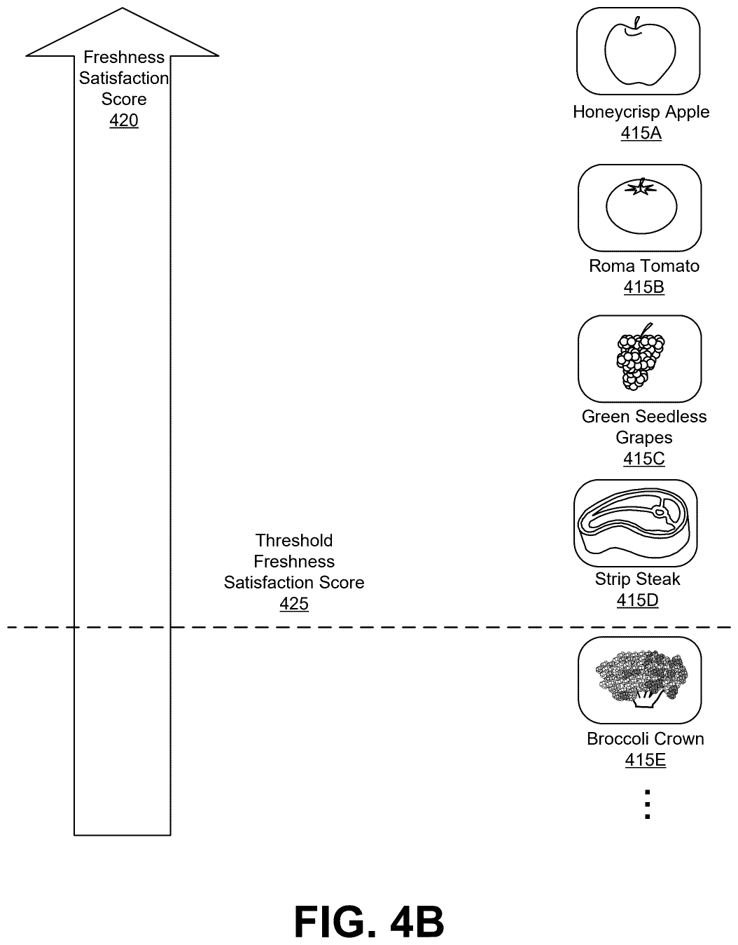

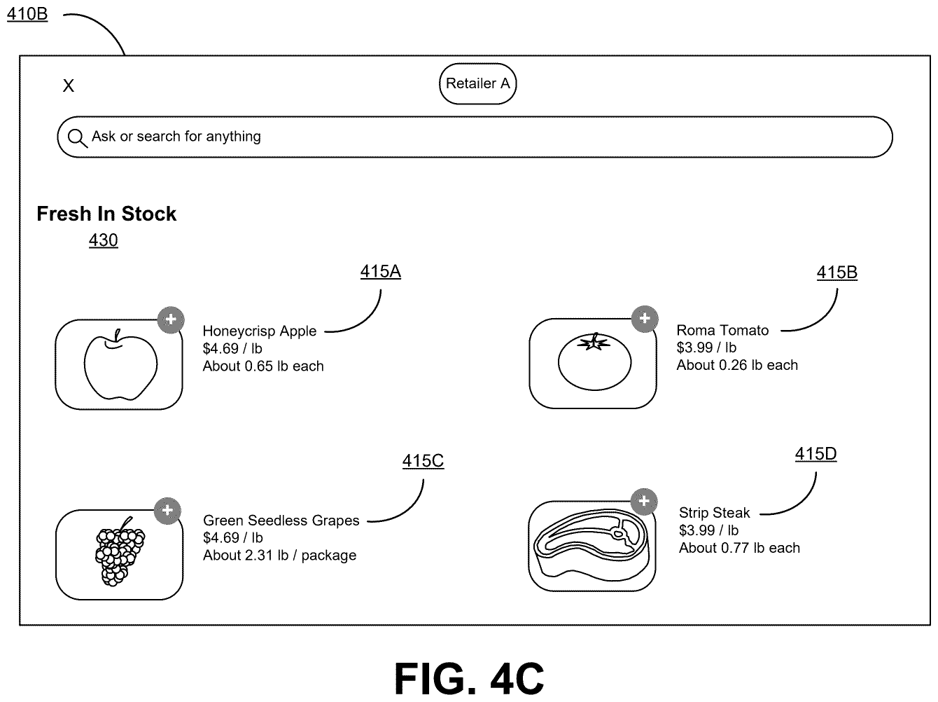

FIG. 4A illustrates an example of a user interface including information describing items included among an inventory at a retailer location, in accordance with one or more embodiments. In the example of FIG. 4A, the online concierge system 140 may generate a freshness indicator 405A-D for each of multiple items included in the user interface 410A based on a freshness satisfaction score for each item, in which the freshness indicator 405A-D indicates where the user's measure of satisfaction with the freshness of a corresponding item falls along a range (e.g., from 0 to 100, with 0 being the lowest and 100 being the highest). In this example, the online concierge system 140 may generate 335 the user interface 410A including the freshness indicator 405A-D and other information (e.g., a name, an image, a price, etc.) describing each item. In the above example, the freshness indicators 405A-D for the items included in the user interface 410A indicate the Honeycrisp apple has a higher freshness satisfaction score than the Roma tomato, which has a higher freshness satisfaction score than the green seedless grapes, which have a higher freshness satisfaction score than the broccoli crown.

In some embodiments, the online concierge system 140 determines (e.g., using the selection module 214) whether the freshness satisfaction score for the item is at least a threshold score. In such embodiments, the online concierge system 140 generates 335 the user interface 410 including information describing the item responsive to determining the freshness satisfaction score for the item is at least the threshold score. Furthermore, in such embodiments, the user interface 410 also includes information indicating the freshness of the item.

FIG. 4B illustrates examples of freshness satisfaction scores for items included among an inventory at a retailer location, in accordance with one or more embodiments, while FIG. 4C illustrates an example of a user interface including information describing items associated with at least a threshold freshness satisfaction score that are included among an inventory at a retailer location, in accordance with one or more embodiments. Referring first to FIG. 4B, if the item 415A is a Honeycrisp apple, the online concierge system 140 may compare (e.g., using the selection module 214) the freshness satisfaction score 420 for the item 415A to a threshold score 425 and determine whether the freshness satisfaction score 420 is at least the threshold score 425. In this example, the online concierge system 140 may repeat this process for additional items 415B-E included among the inventory at the retailer location. In this example, if the online concierge system 140 determines the freshness satisfaction score 420 for an item 415A-D, such as the Honeycrisp apple, the Roma tomato, the green seedless grapes, or the strip steak, is at least the threshold score 425, the online concierge system 140 may include information (e.g., a name, an image, a price, etc.) describing the item 415A-D in the user interface 410B, as shown in FIG. 4C. Furthermore, in the above example, if the online concierge system 140 determines the freshness satisfaction score 420 for an item 415E, such as the broccoli crown, is not at least the threshold score 425, the online concierge system 140 may not include information describing the item 415E in the user interface 410B, as also shown in FIG. 4C. Additionally, as shown in FIG. 4C, the user interface 410B may indicate the items 415A-D included in the user interface 410B are fresh by labeling them as “Fresh In Stock” 430.

Referring back to FIG. 3, the online concierge system 140 then sends 340 (e.g., using the interface module 211) the user interface 410 to the user client device 100, causing the user client device 100 to display the user interface 410. For example, the online concierge system 140 may send 340 the user interface 410A shown in FIG. 4A or the user interface 410B shown in FIG. 4C to the user client device 100. In this example, once sent 340, the user client device 100 may display the user interface 410A or 410B.

Referring once more to FIG. 3, in some embodiments, the online concierge system 140 also sends 345 (e.g., using the communication module 215) information to a retailer computing system 120 operated by the retailer describing the measure of satisfaction of the user with the freshness of the item 415. The online concierge system 140 and the retailer computing system 120 operated by the retailer may communicate via messages (e.g., text messages), audio or video communications (e.g., a phone call, a voice-over-IP call, or a video call), or via any other suitable method of communication. The online concierge system 140 also may send additional types of information to the retailer computing system 120 operated by the retailer, such as information describing an environment in which the item 415 should be stored (e.g., to prolong its shelf life).

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, from a client device associated with a user of an online concierge system, a request to access a user interface comprising information describing one or more items included among an inventory at a retailer location;
retrieving a set of item data for an item included among the inventory at the retailer location;
accessing a machine-learning model trained to predict a freshness satisfaction score for the item, wherein the freshness satisfaction score indicates a measure of satisfaction of the user with a freshness of the item and the machine-learning model is trained by:
receiving item data for a plurality of items,
receiving conversion data for a plurality of conversions by a plurality of users of the online concierge system;
receiving, for each conversion of the plurality of conversions, a label describing the measure of satisfaction of a corresponding user with the freshness of a set of items associated with the conversion, and
training the machine-learning model based at least in part on the item data, the conversion data, and the label for each conversion of the plurality of conversions;
applying the machine-learning model to predict the freshness satisfaction score for the item based at least in part on the set of item data for the item;
generating the user interface comprising the information describing the one or more items based at least in part on the freshness satisfaction score for the item; and
sending the user interface to the client device associated with the user, wherein sending the user interface causes the client device to display the user interface.

2. The method of claim 1, wherein the machine-learning model is further trained by:
receiving user data for the plurality of users; and
training the machine-learning model based at least in part on the user data.

3. The method of claim 2, wherein applying the machine-learning model to predict the freshness satisfaction score for the item based at least in part on the set of item data for the item comprises applying the machine-learning model to predict the freshness satisfaction score for the item based at least in part on a set of user data for the user.

4. The method of claim 1, wherein applying the machine-learning model to predict the freshness satisfaction score for the item based at least in part on the set of item data for the item comprises applying the machine-learning model to predict the freshness satisfaction score for the item based at least in part on one or more of: information describing a seasonality of the item, information describing an availability of the item, environmental information associated with the item, historical conversion information associated with the item, or information describing a life cycle of the item.

5. The method of claim 4, wherein applying the machine-learning model to predict the freshness satisfaction score for the item based at least in part on environmental information associated with the item comprises applying the machine-learning model to predict the freshness satisfaction score for the item based at least in part on one or more of: a temperature of a location associated with the item, a humidity of the location associated with the item, or a light exposure of the location associated with the item.

6. The method of claim 4, wherein applying the machine-learning model to predict the freshness satisfaction score for the item based at least in part on historical conversion information associated with the item comprises applying the machine-learning model to predict the freshness satisfaction score for the item based at least in part on one or more of: a time associated with a previous conversion associated with the item or user data associated with a user associated with a previous conversion associated with the item.

7. The method of claim 4, wherein applying the machine-learning model to predict the freshness satisfaction score for the item based at least in part on information describing a life cycle of the item comprises applying the machine-learning model to predict the freshness satisfaction score for the item based at least in part on one or more of: a harvest date associated with the item, a shipping and handling time associated with the item, an amount of time elapsed since the item became available for acquisition, or a shelf life associated with the item.

8. The method of claim 1, wherein generating the user interface comprising the information describing the one or more items based at least in part on the freshness satisfaction score for the item comprises:
determining that the freshness satisfaction score for the item is at least a threshold score; and
responsive to determining that the freshness satisfaction score for the item is at least the threshold score, generating the user interface comprising the information describing the one or more items and information indicating the freshness of the item.

9. The method of claim 1, wherein generating the user interface comprising the information describing the one or more items based at least in part on the freshness satisfaction score for the item comprises:
generating an indicator based at least in part on the freshness satisfaction score for the item; and
generating the user interface comprising the information describing the one or more items, wherein the information describing the one or more items comprises the indicator.

10. The method of claim 1, further comprising:
ranking the one or more items based at least in part on the freshness satisfaction score for the item; and
selecting the one or more items based at least in part on the ranking.

11. A computer program product comprising a non-transitory computer-readable storage medium having instructions encoded thereon that, when executed by a processor, cause the processor to perform steps comprising:
receiving, from a client device associated with a user of an online concierge system, a request to access a user interface comprising information describing one or more items included among an inventory at a retailer location;
retrieving a set of item data for an item included among the inventory at the retailer location;
accessing a machine-learning model trained to predict a freshness satisfaction score for the item, wherein the freshness satisfaction score indicates a measure of satisfaction of the user with a freshness of the item and the machine-learning model is trained by:
receiving item data for a plurality of items,
receiving conversion data for a plurality of conversions by a plurality of users of the online concierge system;
receiving, for each conversion of the plurality of conversions, a label describing the measure of satisfaction of a corresponding user with the freshness of a set of items associated with the conversion, and
training the machine-learning model based at least in part on the item data, the conversion data, and the label for each conversion of the plurality of conversions;
applying the machine-learning model to predict the freshness satisfaction score for the item based at least in part on the set of item data for the item;
generating the user interface comprising the information describing the one or more items based at least in part on the freshness satisfaction score for the item; and
sending the user interface to the client device associated with the user, wherein sending the user interface causes the client device to display the user interface.

12. The computer program product of claim 11, wherein the machine-learning model is further trained by:
receiving user data for the plurality of users; and
training the machine-learning model based at least in part on the user data.

13. The computer program product of claim 12, wherein applying the machine-learning model to predict the freshness satisfaction score for the item based at least in part on the set of item data for the item comprises applying the machine-learning model to predict the freshness satisfaction score for the item based at least in part on a set of user data for the user.

14. The computer program product of claim 11, wherein applying the machine-learning model to predict the freshness satisfaction score for the item based at least in part on the set of item data for the item comprises applying the machine-learning model to predict the freshness satisfaction score for the item based at least in part on one or more of: information describing a seasonality of the item, information describing an availability of the item, environmental information associated with the item, historical conversion information associated with the item, or information describing a life cycle of the item.

15. The computer program product of claim 14, wherein applying the machine-learning model to predict the freshness satisfaction score for the item based at least in part on environmental information associated with the item comprises applying the machine-learning model to predict the freshness satisfaction score for the item based at least in part on one or more of: a temperature of a location associated with the item, a humidity of the location associated with the item, or a light exposure of the location associated with the item.

16. The computer program product of claim 14, wherein applying the machine-learning model to predict the freshness satisfaction score for the item based at least in part on historical conversion information associated with the item comprises applying the machine-learning model to predict the freshness satisfaction score for the item based at least in part on one or more of: a time associated with a previous conversion associated with the item or user data associated with a user associated with a previous conversion associated with the item.

17. The computer program product of claim 14, wherein applying the machine-learning model to predict the freshness satisfaction score for the item based at least in part on information describing a life cycle of the item comprises applying the machine-learning model to predict the freshness satisfaction score for the item based at least in part on one or more of: a harvest date associated with the item, a shipping and handling time associated with the item, an amount of time elapsed since the item became available for acquisition, or a shelf life associated with the item.

18. The computer program product of claim 11, wherein generating the user interface comprising the information describing the one or more items based at least in part on the freshness satisfaction score for the item comprises:
determining that the freshness satisfaction score for the item is at least a threshold score; and
responsive to determining that the freshness satisfaction score for the item is at least the threshold score, generating the user interface comprising the information describing the one or more items and information indicating the freshness of the item.

19. The computer program product of claim 11, wherein generating the user interface comprising the information describing the one or more items based at least in part on the freshness satisfaction score for the item comprises:
generating an indicator based at least in part on the freshness satisfaction score for the item; and
generating the user interface comprising the information describing the one or more items, wherein the information describing the one or more items comprises the indicator.

20. A computer system comprising:
a processor; and
a non-transitory computer-readable storage medium storing instructions that, when executed by the processor, perform actions comprising:
receiving, from a client device associated with a user of an online concierge system, a request to access a user interface comprising information describing one or more items included among an inventory at a retailer location;
retrieving a set of item data for an item included among the inventory at the retailer location;
accessing a machine-learning model trained to predict a freshness satisfaction score for the item, wherein the freshness satisfaction score indicates a measure of satisfaction of the user with a freshness of the item and the machine-learning model is trained by:
receiving item data for a plurality of items,
receiving conversion data for a plurality of conversions by a plurality of users of the online concierge system;
receiving, for each conversion of the plurality of conversions, a label describing the measure of satisfaction of a corresponding user with the freshness of a set of items associated with the conversion, and
training the machine-learning model based at least in part on the item data, the conversion data, and the label for each conversion of the plurality of conversions;
applying the machine-learning model to predict the freshness satisfaction score for the item based at least in part on the set of item data for the item;
generating the user interface comprising the information describing the one or more items based at least in part on the freshness satisfaction score for the item; and
sending the user interface to the client device associated with the user, wherein sending the user interface causes the client device to display the user interface.
